(19) United States
(12) Patent Application Publication
(10) Pub. No.: US 2026/0347553 A1
(43) Pub. Date: Nov. 5, 2026

(54) WATER-SOLUBLE FILM AND METHOD FOR PRODUCING SAME, PACKAGE, CHEMICAL AGENT PACKAGE, AND METHODS FOR PRODUCING SAME

(71) Applicant: MITSUBISHI CHEMICAL CORPORATION, Tokyo (JP)

(72) Inventors: Kenji KANETA, Tokyo (JP); Madoka TERAZAWA, Tokyo (JP); Nobuyoshi YOSHIMURA, Tokyo (JP)

(73) Assignee: MITSUBISHI CHEMICAL CORPORATION, Tokyo (JP)

(21) Appl. No.: 19/709,616

(22) Filed: Jun. 16, 2026

Related U.S. Application Data
(63) Continuation of application No. PCT/JP2025/011958, filed on Mar. 26, 2025.

(30) Foreign Application Priority Data
Mar. 27, 2024 (JP) 2024-051594
May 22, 2024 (JP) 2024-083418

(51) Int. Cl. C08J 5/18; C08L 3/02; C08L 29/04; C11D 17/04

(52) U.S. Cl. CPC C08J 5/18; C08L 3/02; C08L 29/04; C11D 17/043; C08J 2303/02; C08J 2329/04; C08J 2403/02; C08J 2405/00; C08J 2429/04; C08L 2203/162; C08L 2205/025; C08L 2205/03

(57) ABSTRACT

Provided below is a water-soluble film containing a polyvinyl alcohol-based resin and at least one naturally derived material selected from the group consisting of a saccharide, a sugar alcohol, a lipid, a protein, and a salt thereof, wherein a content of the naturally derived material is 40 mass % or more based on 100 mass % of the water-soluble film (solid content), and a viscosity of a 1 mass % aqueous solution of the water-soluble film at 20 °C is from 2.00 to 2.60 mPa·s, and which has excellent mechanical properties such as strength and stretchability and also excellent water sealing properties useful for packaging applications, when a polyvinyl alcohol-based resin is used in combination with a naturally derived material at a relatively high content.

### RELATED APPLICATIONS

This application is a continuation of International Application No. PCT/JP2025/011958, filed on Mar. 26, 2025, which claims priority to Japanese Patent Application No. 2024-051594, filed on Mar. 27, 2024, and Japanese Patent Application No. 2024-083418, filed on May 22, 2024, the entire contents of each of which are herein incorporated by reference.

### TECHNICAL FIELD

The present disclosure relates to a water-soluble film containing a naturally derived material. More specifically, the present disclosure relates to a water-soluble film containing a naturally derived material in a specific amount or more, a package and a chemical agent package using the same, and methods for producing the water-soluble film, the package, and the chemical agent package.

### BACKGROUND ART

In recent years, from the viewpoint of protecting the global environment, the development of films having higher biodegradability, using naturally derived materials, has been expected in place of conventional plastic films made from petroleum-derived materials.

Meanwhile, as shown in Patent Literature 1 and Patent Literature 2, a water-soluble film using pullulan, which is a water-soluble polysaccharide as a naturally derived material, has been known. For example, Patent Literature 1 describes a water-soluble film containing pullulan and polyvinyl alcohol and describes that the film is excellent in printability and adhesiveness. Patent Literature 2 describes a film containing pullulan as a naturally derived material and a water-soluble polymer and describes that the film can be used for edible applications.

### CITATION LIST

### Patent Literature

Patent Literature 1: JP 5-001198 A
Patent Literature 2: JP 2005-528328 T

### SUMMARY

### Technical Problem

However, when a polyvinyl alcohol-based resin is used together with a naturally derived material such as pullulan, as in the water-soluble films of Patent Literature 1 and Patent Literature 2, the resulting film has poor physical properties and sealing properties. In particular, in individual packaging applications, for example, for food and chemical agents, sealing properties are also required together with mechanical properties such as strength and stretchability. Thus, further improvements have been required to yield a film having higher toughness and more excellent sealing properties.

Accordingly, under such circumstances, the present disclosure provides a water-soluble film having excellent mechanical properties such as strength and stretchability and also excellent water sealing properties useful for packaging applications when a polyvinyl alcohol-based resin is used in combination with a naturally derived material at a relatively high content and a method for producing the same, a package and a chemical agent package thereof, and methods for producing the package and the chemical agent package.

### Solution to Problem

Accordingly, as a result of intensive studies conducted in view of such circumstances, the present inventor has found that, in a water-soluble film containing a polyvinyl alcohol-based resin used in combination with a naturally derived material at a relatively high content, by setting the viscosity of a 1 mass % aqueous solution of the water-soluble film at 20 °C to from 2.00 to 2.60 mPa·s, a water-soluble film having excellent mechanical properties and excellent sealing properties useful for packaging applications can be obtained.

In addition, since the polyvinyl alcohol-based resin is a biodegradable resin, the above problem can be solved without significantly reducing the biodegradability of the water-soluble film as a whole.

That is, the present disclosure provides the following aspects.

[1]A water-soluble film containing a polyvinyl alcohol-based resin and at least one naturally derived material selected from the group consisting of a saccharide, a sugar alcohol, a lipid, a protein, and a salt thereof,
wherein a content of the naturally derived material is 40 mass % or more based on 100 mass % of the water-soluble film (solid content), and
a viscosity of a 1 mass % aqueous solution of the water-soluble film at 20 °C is from 2.00 to 2.60 mPa·s.

[2] The water-soluble film according to [1], wherein the naturally derived material includes a naturally derived material having a weight-average molecular weight of 10000 or more.

[3]A method for producing the water-soluble film described in [1] or [2], the method including:
preparing a film-forming raw material containing the polyvinyl alcohol-based resin and the naturally derived material;
casting the film-forming raw material onto a casting surface; and drying the film-forming raw material cast on the casting surface.

[4]A package containing the water-soluble film described in any one of [1] to [3].

[5]A chemical agent package containing a package containing the water-soluble film described in any one of [1] to [4], and a chemical agent enclosed in the package.

[6] The chemical agent package according to [5], wherein the chemical agent is a liquid detergent.

[7]A method for producing the chemical agent package described in [5] or [6], the method including:
preparing a first water-soluble film, a second water-soluble film, and the chemical agent;
placing the chemical agent between the first water-soluble film and the second water-soluble film; and

contacting and pressure-bonding the first water-soluble film and the second water-soluble film.

### Advantageous Effects of Disclosure

The water-soluble film of the present disclosure has excellent mechanical properties, as well as excellent water sealing properties. Thus, the water-soluble film is suitable for individual packaging applications. Particularly, the water-soluble film is excellent as an individual package for chemical agents and foods.

### DESCRIPTION OF EMBODIMENTS

The present disclosure will be described below with reference to embodiments for carrying out the present disclosure. However, the present disclosure is not limited to the embodiments described below.

In the present specification, “x and/or y (x and y are any configurations)” means at least one of x and y, that is, means three ways of x only, y only, and x and y.

In addition, in the present specification, the expression of “from X to Y” (where X and Y are any numbers) includes the meaning of “X or more and Y or less” and the meaning of “preferably more than X” or “preferably less than Y”, unless otherwise specified.

In addition, when the expression “X or greater” (X being any number) or “Y or less” (Y being any number) is used in the present specification, the expression also includes the meaning of “preferably greater than X” or “preferably less than Y”.

In the present specification, for numerical ranges described stepwise, the upper limit value or the lower limit value of a numerical range in a certain step can be optionally combined with the upper limit value or the lower limit value of a numerical range in another step. In addition, for a numerical range described herein, the upper limit value or the lower limit value of the numerical range can be replaced by a value shown in Examples.

Hereinafter, the present disclosure will be described in detail.

A “water-soluble film” in the present disclosure means a film that dissolves in water at normal temperature (around 20 °C).

In the present disclosure, dissolution of the film is evaluated as follows.

That is, the film is cut into a size of 3 cm×5 cm, placed in a 1-liter beaker containing water (1 liter), and fixed with a jig, and the mixture is stirred with a stirrer (stirring bar length: 3 cm, rotation speed: 750 rpm) while maintaining the water temperature at 20 °C. When no insoluble fine particles of the film having a diameter of 1 mm or more are observed, the film is determined to be “dissolved.”

The water-soluble film according to one embodiment of the present disclosure (hereinafter referred to as “the present water-soluble film”) contains a polyvinyl alcohol-based resin and at least one naturally derived material selected from the group consisting of a saccharide, a sugar alcohol, a lipid, a protein, and a salt thereof.

In the present specification, the term “naturally derived material” refers to a raw material derived from a plant, an animal, or a microorganism and obtained by physical treatment such as drying or crushing without chemical synthesis (natural material), or a raw material obtained by subjecting the natural material to chemical synthesis without introduction of a carbon atom derived from a non-natural material.

The present water-soluble film contains a relatively high content of such a naturally derived material as compared with conventional films from the viewpoint of protecting the global environment. The content of the naturally derived material is 40 mass % or more, preferably 43 mass % or more, more preferably 45 mass % or more, still more preferably 47 mass % or more, and particularly preferably 50 mass % or more, based on 100 mass % of the solid content of the water-soluble film. The upper limit value is usually 90 mass %, and from the viewpoint of maintaining the film shape, is preferably 80 mass % or less, and may be 75 mass % or less. The numerical range of the content is, for example, from 40 to 90 mass %.

Usually, as a content of a naturally derived material in a water-soluble film increases, the film properties are impaired, and commercialization of the film in various applications tends to be difficult. However, the present water-soluble film can prevent such a decrease in water sealing properties and mechanical strength thereof while containing a higher content of the naturally derived material than conventional films by setting the viscosity of a 1 mass % aqueous solution of the water-soluble film at 20 °C to 2.00 mPa·s or more and 2.60 mPa·s or less.

In the present specification, polyvinyl alcohol may be abbreviated as “PVA.”

In addition, the term “film” means to include a “tape” and a “sheet.”

### Water-Soluble Film

The present water-soluble film is a water-soluble film containing, as a main component, a total of a PVA-based resin (A) and the above naturally derived material (excluding plasticizers and fillers).

As used herein, the term “main component” refers to the most abundant component in an object, and the content of the main component is usually 50 mass % or more, preferably 60 mass % or more, more preferably 70 mass % or more, still more preferably 80 mass % or more, and particularly preferably 90 mass % or more, and may be 100 mass %, in the object.

### PVA-Based Resin (A)

Examples of the PVA-based resin (A) used in the present water-soluble film include an unmodified PVA resin and a modified PVA-based resin.

The unmodified PVA resin and the modified PVA-based resin can be produced by production methods known in the art. For example, the unmodified PVA resin and the modified PVA-based resin are produced as follows.

The unmodified PVA can be produced by saponifying a vinyl ester-based polymer obtained by polymerizing a vinyl ester-based compound.

Examples of the vinyl ester-based compound include vinyl formate, vinyl acetate, vinyl trifluoroacetate, vinyl propionate, vinyl butyrate, vinyl caprate, vinyl laurate, vinyl versatate, vinyl palmitate, and vinyl stearate. However, vinyl acetate is preferably used. The above vinyl ester-based compounds may be used singly or in combination of two or more thereof.

The modified PVA-based resin can be produced by copolymerizing the vinyl ester-based compound and an unsaturated monomer copolymerizable with the vinyl ester-based compound, followed by saponification.

Examples of the unsaturated monomer copolymerizable with the vinyl ester-based compound include olefins such as ethylene, propylene, isobutylene, α-octene, α-dodecene, and α-octadecene; hydroxy group-containing α-olefins such as 3-buten-1-ol, 4-penten-1-ol, and 5-hexen-1-ol, and derivatives thereof such as acylated compounds thereof; unsaturated acids such as acrylic acid, methacrylic acid, crotonic acid, maleic acid, maleic anhydride, itaconic acid, and undecylenic acids, salts thereof, and monoesters or dialkyl esters thereof; amides such as diacetone acrylamide, acrylamide, and methacrylamide; olefin sulfonic acids such as ethylenesulfonic acid, allylsulfonic acid, and methallylsulfonic acid, or salts thereof; and N-vinylpyrrolidone. These can be used singly or in combination of two or more thereof.

The modified PVA-based resin has, for example, a primary hydroxyl group in its side chain. For example, the number of primary hydroxyl groups in the side chain is typically 1 to 5, preferably 1 to 2, and particularly preferably 1. Furthermore, the modified PVA-based resin preferably has a secondary hydroxyl group in addition to the primary hydroxyl group. Examples of the modified PVA-based resin include a PVA-based resin having a hydroxyalkyl group in its side chain and a PVA-based resin having a 1,2-diol structural unit in its side chain. The PVA-based resin having a 1,2-diol structural unit in its side chain can be produced by, for example, (1) a method in which a copolymer of vinyl acetate and 3,4-diacetoxy-1-butene is saponified; (2) a method in which a copolymer of vinyl acetate and vinyl ethylene carbonate is saponified and decarbonated; (3) a method in which a copolymer of vinyl acetate and 2,2-dialkyl-4-vinyl-1,3-dioxolane is saponified and deketalized; or (4) a method in which a copolymer of vinyl acetate and glycerin monoallyl ether is saponified.

The modified PVA-based resin used in the present water-soluble film is preferably modified with at least one hydrophilic group selected from, for example, anionic groups such as a carboxy group, a sulfonic acid group, and a phosphoric acid group, a pyrrolidone ring group, and an amino group, from the viewpoint of solubility. Among these, an anionic group-modified PVA-based resin is preferably used. Examples of these modifying groups also include salts of the functional groups described above, such as a sodium salt thereof and a potassium salt thereof.

Hereinafter, the modified PVA-based resin modified with a hydrophilic group may be simply referred to as a “hydrophilic group-modified PVA-based resin.”

Examples of the hydrophilic group-modified PVA-based resin include anionic group-modified PVA-based resins such as carboxy group-modified PVA-based resins, sulfonic acid group-modified PVA-based resins, and phosphoric acid group-modified PVA-based resins, pyrrolidone ring-modified PVA-based resins, and amino group-modified PVA-based resins.

### Anionic Group-Modified PVA-Based Resin

An anionic group-modified PVA-based resin has an anionic group. Examples of the anionic group include a carboxy group, a sulfonic acid group, and a phosphoric acid group. Among these, a carboxy group and a sulfonic acid group are preferred, and a carboxy group is more preferred, from the viewpoint of excellent solubility in water and chemical resistance.

The anionic group-modified PVA-based resin can be produced, for example, by saponifying a copolymer of a vinyl ester-based monomer and an unsaturated monomer having an anionic group, or by post-modifying a PVA-based resin.

Examples of the unsaturated monomer having an anionic group include a carboxy group-containing unsaturated monomer, a sulfonic acid group or sulfonate group-containing unsaturated monomer, and a phosphoric acid group-containing unsaturated monomer.

Examples of the carboxy group-containing unsaturated monomer include carboxy group-containing unsaturated compounds such as acrylic acid, methacrylic acid, crotonic acid, maleic acid, maleic anhydride, fumaric acid, and itaconic acid, and the compounds with the carboxy groups thereof wholly or partially neutralized with a base such as an alkali compound (e.g., sodium hydroxide or potassium hydroxide); monoalkyl esters of the above carboxy group-containing unsaturated compounds, such as methyl acrylate, ethyl acrylate, methyl methacrylate, monomethyl fumarate, and monomethyl maleate; and dialkyl esters of the above carboxy group-containing unsaturated compounds, such as diethyl fumarate and diethyl maleate. The number of carbon atoms of these esters is usually from 1 to 20, preferably from 1 to 10, and particularly preferably from 1 to 4, from the viewpoint of economic efficiency and practicality.

Among these, maleic acid-based compounds are preferred, and monomethyl maleate is more preferred.

Examples of the sulfonic acid group- or sulfonate group-containing unsaturated monomer include olefin sulfonic acids such as vinyl sulfonic acid, allyl sulfonic acid, and methallyl sulfonic acid, and salts thereof; sulfoalkyl maleates such as sodium sulfopropyl-2-ethylhexyl maleate, sodium sulfopropyl tridecyl maleate, and sodium sulfopropyl eicosyl maleate; sulfoalkyl (meth)acrylamides such as sodium sulfomethylacrylamide, sodium sulfo-t-butylacrylamide, sodium sulfo-s-butylacrylamide, and sodium sulfo-t-butylmethacrylamide; and sulfoalkyl (meth)acrylates such as sodium sulfomethylacrylamide, sodium sulfo-t-butylacrylamide, sodium sulfo-s-butylacrylamide, and sodium sulfo-t-butylmethacrylamide. One or more unsaturated monomers selected from these unsaturated monomers can be used.

In the present specification, the term “(meth)acryl” means acryl and/or methacryl, and the term “(meth)acrylate” means acrylate and/or methacrylate.

Examples of the phosphoric acid group-containing unsaturated monomer include phosphonocarboxylic acid compounds or alkali metal salts thereof.

Examples of the vinyl ester-based monomer to be copolymerized with the above unsaturated monomer include vinyl formate, vinyl acetate, vinyl trifluoroacetate, vinyl propionate, vinyl butyrate, vinyl caprate, vinyl laurate, vinyl versatate, vinyl palmitate, and vinyl stearate. These can be used singly or in combination of two or more thereof, but vinyl acetate is preferred in practice.

As the polymerization method, a known polymerization method such as solution polymerization, emulsion polymerization, or suspension polymerization can be optionally used. However, the polymerization method is usually carried out by solution polymerization using an alcohol such as methanol, ethanol, or isopropyl alcohol as a solvent.

As the polymerization catalyst, a known polymerization catalyst such as an azo-based catalyst (e.g., azobisisobutyronitrile) or a peroxide catalyst (e.g., acetyl peroxide, benzoyl peroxide, and lauroyl peroxide) can be appropriately selected depending on the polymerization method. The polymerization catalyst can be used singly or in combination of two or more thereof. The reaction temperature is selected from a range from 35 °C to about the boiling point of the solvent.

The saponification can also be carried out by a known method. The saponification is usually carried out by dissolving the obtained polymer in an alcohol in the presence of a saponification catalyst. Examples of the alcohol include methanol, ethanol, and butanol. These can be used singly or in combination of two or more thereof. The concentration of the copolymer in the alcohol is selected from the range of 20 mass % or more and 50 mass % or less from the viewpoint of solubility.

As the saponification catalyst, for example, an alkali catalyst such as a hydroxide or alcoholate of an alkali metal (e.g., sodium hydroxide, potassium hydroxide, sodium methylate, sodium ethylate, or potassium methylate) can be used, and an acid catalyst may also be used. These can be used singly or in combination of two or more thereof. The amount of the saponification catalyst used is preferably from 1 to 100 mmol equivalents relative to the vinyl ester-based compound.

The degree of modification of the anionic group-modified PVA-based resin is preferably from 1 to 15 mol %, more preferably from 2 to 10 mol %, still more from preferably 2 to 8 mol %, and particularly preferably from 3 to 7 mol %. When the degree of modification is too low, the solubility in water tends to be reduced. When the degree of modification is too high, the productivity of the PVA-based resin tends to be reduced, the biodegradability tends to be reduced, blocking tends to be caused, and practicality tends to be reduced.

The viscosity of a 4 mass % aqueous solution of the anionic group-modified PVA-based resin at 20 °C is preferably from 5 to 50 mPa·s, more preferably from 13 to 40 mPa·s, and still more preferably from 17 to 30 mPa·s. When the viscosity is too low, the mechanical strength of the water-soluble film tends to be reduced, whereas when it is too high, there is a tendency that the viscosity of the aqueous solution during film formation increases and the productivity is reduced.

The average degree of saponification of the anionic group-modified PVA-based resin is preferably 80 mol % or more, more preferably from 85 to 99.9 mol %, still more preferably from 88 to 99 mol %, and particularly preferably from 90 to 98 mol %. When the degree of saponification is too high, solubility in water tends to decrease, and when it is too low, solubility of the water-soluble film in water tends to decrease over time depending on the agent to be packaged.

In the present embodiment, the above PVA-based resin (A) may be used singly, or two or more PVA-based resins (A) having different degrees of saponification, viscosities, types of modification, degrees of modification, and the like may be used in combination.

In the present embodiment, from the viewpoint of compatibility with the naturally derived material, it is preferable to contain the anionic group-modified PVA-based resin as the PVA-based resin (A).

In particular, from the viewpoint of the balance between compatibility and water solubility and ease of handling, a carboxy group-modified PVA-based resin and a sulfonic acid group-modified PVA-based resin are preferably used, and a carboxy group-modified PVA is particularly preferably used.

The PVA-based resin (A) preferably has an average degree of saponification of 80 mol % or more, more preferably from 82 to 99.9 mol %, still more preferably from 85 to 99 mol %, and particularly preferably from 90 to 98 mol %. When the average degree of saponification is too low, solubility of the film in water tends to be reduced, and depending on the agent to be packaged, the solubility of the film may be reduced over time. When the average degree of saponification is too high, the solubility in water also tends to be reduced.

The viscosity of a 4 mass % aqueous solution of the PVA-based resin (A) at 20 °C is preferably from 5 to 60 mPa·s, more preferably from 10 to 45 mPa·s, and still more preferably from 15 to 40 mPa·s. When the viscosity is too low, the mechanical strength of the water-soluble film tends to be reduced, and when it is too high, there is a tendency that the viscosity of the aqueous solution during film formation increases and the productivity is reduced.

The content of the PVA-based resin (A) is preferably from 10 to 90 mass %, more preferably from 20 to 80 mass %, and still more preferably from 30 to 70 mass %, of the water-soluble film, but in the present water-soluble film, it is preferably 60 mass % or less, more preferably 57 mass % or less, still more preferably 55 mass % or less, and particularly preferably 52 mass % or less, of the water-soluble film. When the content of the PVA-based resin (A) is within the above range, the mechanical properties of the film, particularly the elongation of the film, tend(s) to be enhanced.

In the present water-soluble film, the hydrophilic group-modified PVA-based resin and a PVA-based resin other than the hydrophilic group-modified PVA-based resin can be used in combination. For example, unmodified PVA can also be used in combination from the viewpoint of adjusting film properties such as sealing properties and viscoelasticity.

When the hydrophilic group-modified PVA-based resin and the unmodified PVA are used in combination, the content ratio (mass ratio) of the hydrophilic group-modified PVA-based resin to the unmodified PVA is preferably from 97/3 to 50/50, more preferably from 95/5 to 70/30, and still more preferably from 93/7 to 85/15. When the content ratio is too large, the compatibility between the PVA-based resin (A) and the naturally derived material tends to decrease.

### Naturally Derived Material

The naturally derived material used for the present water-soluble film is at least one naturally derived material selected from the group consisting of a saccharide, a sugar alcohol, a lipid, a protein, and a salt thereof.

The content of the naturally derived material is 40 mass % or more, preferably 43 mass % or more, more preferably 45 mass % or more, still more preferably 47 mass % or more, and particularly preferably 50 mass % of the water-soluble film (solid content, the same applies hereinafter). The upper limit value is preferably 90 mass % or less, more preferably 80 mass % or less, still more preferably 75 mass % or less, particularly preferably 70 mass % or less, and especially preferably 65 mass % or less. The numerical range of the content is, for example, from 40 to 90 mass %.

The mass ratio of the naturally derived material to the PVA-based resin (A) (naturally derived material/PVA-based resin) is usually from 1/99 to 99/1, preferably from 10/90 to 90/10, more preferably from 20/80 to 80/20, even more preferably from 30/70 to 70/30, and particularly preferably from 40/60 to 60/40.

When the content ratio of the naturally derived material is too large, the compatibility with the PVA-based resin (A) tends to deteriorate and the solubility of the film in water tends to be reduced. In addition, mechanical properties such as film strength tend to decrease.

In the naturally derived material, it is preferable to contain a naturally derived material which is a polymer from the viewpoint of achieving a specific viscosity. The weight-average molecular weight (Mw) of such a polymer is preferably 10000 or more, more preferably 50000 or more, still more preferably 100000 or more, particularly preferably 150000 or more, and especially preferably 1000000 or more. The upper limit value is not particularly limited, but is usually 1×10⁹ or less, and the numerical range of the weight-average molecular weight is from 10000 to 1×10⁹. The weight-average molecular weight is usually measured by a GPC method, but for high-molecular-weight substances such as starch, the weight-average molecular weight is measured by a high-performance liquid chromatography (HPLC) method or a high-performance anion-exchange chromatography (HPAE) method.

The content of the polymer having a weight-average molecular weight of 10000 or more, more preferably 50000 or more, still more preferably 100000 or more, particularly preferably 150000 or more, and especially preferably 1000000 or more, in the naturally derived material is preferably such that the polymer is a main component of the naturally derived material, excluding a plasticizer described later, and is more preferably 60 mass % or more, still more preferably 70 mass % or more, particularly preferably 80 mass % or more, and especially preferably 90 mass % or more. The upper limit value is 100 mass %. The numerical range of the content is, for example, from 60 to 100 mass %.

Hereinafter, the saccharide, the sugar alcohol, the lipid, and the protein will be described in detail.

### Saccharide

The saccharide is not particularly limited, provided that sugar alcohols are excluded. Examples of the saccharide include monosaccharides such as glucose, fructose, and galactose; disaccharides such as sucrose, lactose, and maltose; trisaccharides such as maltotriose; oligosaccharides such as fructooligosaccharides, galactooligosaccharides, and isomaltooligosaccharides; and polysaccharides such as pullulan, starch (amylose and amylopectin), cellulose, glycogen, dextrin, chitosan, and chitin. These can be used singly or in combination of two or more thereof. In particular, pullulan and starch are preferred.

In general, when a polysaccharide is contained, an impairment in the physical properties of the water-soluble film is expected. However, in the present embodiment, such an impairment in the film properties can be effectively suppressed even when the polysaccharide is contained.

The content of the polysaccharide is preferably 10 mass % or more, more preferably 15 mass % or more, and still more preferably 20 mass % or more, of the water-soluble film. The upper limit value is preferably 60 mass % or less, more preferably 55 mass % or less, still more preferably 45 mass % or less, and particularly preferably 40 mass % or less. The numerical range of the content is, for example, from 10 to 60 mass %. By incorporating such a polysaccharide in a certain amount or more, the water-soluble film can be used as a sustainable resource with a smaller environmental load.

### Pullulan

Pullulan is a polysaccharide composed solely of glucose. Pullulan has a structure with a plurality of maltotrioses, each of which contains three glucose molecules linked by an α-1,4 bond, being connected by an α-1,6 bond. Generally, pullulan is obtained by culturing a microorganism (a type of filamentous fungus) in a medium containing starch syrup. It is easily dissolved in water and has properties such as lubricity, adhesiveness, cohesiveness, adhesion, tackiness, film-forming properties, and moldability.

### Starch

The starch is not particularly limited. Examples thereof include corn starch, potato starch, wheat starch, rice starch, tapioca starch, sweet potato starch, sago palm starch, soybean starch, arrowroot starch, bracken starch, lotus starch, cassava starch, waxy corn starch, high-amylose corn starch, and commercially available amylose powders. These may be used alone or in combination of two or more thereof. Among these, waxy corn starch having a high amylopectin content is preferred.

In the present specification, the term “starch” refers to unmodified starch, excluding starch derivatives with a functional group introduced into a hydroxyl group of the starch and chemically modified starch derivatives such as oxidized starch, and means starch not subjected to a chemical treatment.

Examples of the starch include, in addition to raw starch, physically processed starch subjected to a physical treatment, such as pregelatinized starch and heat-moisture treated starch (e.g., pregelatinized starch, fractionated amylose, and heat-moisture treated starch), degraded starch obtained by decomposition of starch with an acid (e.g., acid-treated starch), and enzyme-treated starch obtained by decomposition of starch with an enzyme (e.g., hydrolyzed dextrin, enzymatically degraded dextrin, and amylose). From the viewpoint of solubility in water and compatibility with the PVA-based resin, physically processed starch is preferred, and pregelatinized starch is more preferred.

The amylopectin content of the starch is 85 mass % or more, preferably 90 mass % or more, more preferably 95 mass % or more, and still more preferably 98 mass % or more, from the viewpoint of mechanical properties, moldability, and sealing properties. The upper limit value is not particularly limited, but is usually 100 mass %. The numerical range of the content is, for example, from 85 to 100 mass %. When the starch is a mixture of two or more starches, the amylopectin content of the mixture may be 85 mass % or more.

Note that the starch described in the present specification includes starch used as a filler described below (i.e, starch that is present as starch particles of 0.1 μm or more in the water-soluble film and does not dissolve but disperses in water at about normal temperature (20 °C)) provided that the starch used as a filler is a naturally derived material.

The amylopectin content means the mass ratio of amylopectin when the total amount of amylose and amylopectin contained in the starch is taken as 100 mass %.

The amylopectin content can be measured by a colorimetric method using an iodine reaction product, or by a quantitative method using concanavalin A described in Carbohydrate Research, Vol. 180, 301-313 or Starch/Starke, Vol. 42, 302-305.

When the starch is a mixture of two or more starches, the weighted average of the amylopectin contents of the respective starches may be taken as the amylopectin content of the starch (mixture) or the amylopectin content of the mixture of the two or more starches may be measured by the above-described method and the resulting value may be taken as the amylopectin content of the starch.

When the amylopectin content is calculated by a weighted average, it can be determined from the amylopectin ratios of the respective starches by the following formula:

Amylopectin content(mass %) of starch=Σ(nₐi×Mₐi)/100

nₐi: Amylopectin content (mass %) of each starch

Mₐi: Proportion (mass %) of each starch in the starch.

### Sugar Alcohol

The sugar alcohol is not particularly limited. Examples thereof include glycerol, sugar alcohols of monosaccharides such as erythritol, xylitol, sorbitol, and mannitol; sugar alcohols of disaccharides such as maltitol and lactitol; and hydrogenated starch hydrolysates. These can be used singly or in combination of two or more thereof. In particular, glycerol, sorbitol, xylitol, and sorbitol are preferred.

The sugar alcohol of monosaccharides and the sugar alcohol of disaccharides tend to readily exhibit an effect as plasticizers. The sugar alcohol as the naturally derived material includes a sugar alcohol used as a plasticizer described below, provided that the sugar alcohol used as a plasticizer is a naturally derived material.

### Lipid

Examples of the lipid include glycerides (monoglycerides, diglycerides, and triglycerides) and phospholipids such as lecithin and cephalin.

### Protein

Examples of the protein include casein, gelatin, and collagen. In particular, casein and gelatin are preferred.

### Casein

Casein is a protein that accounts for the majority of the proteins in cow's milk. Casein is mainly composed of a mixture of α-casein, β-casein, and K-casein.

There are several methods for separating casein from cow's milk. For example, casein obtained by addition of an acid is called acid casein and acid casein is industrially produced. However, since acid casein has poor water solubility, a salt of casein having high water solubility and ease of handling is generally used.

Examples of the salt of casein include potassium caseinate, sodium caseinate, calcium caseinate, and magnesium caseinate. These can be used singly or in combination of two or more thereof. In particular, sodium caseinate is preferably used from the viewpoint of solubility in water and compatibility with the PVA-based resin.

### Gelatin

Gelatin is obtained by extracting collagen, which is a main component of bones and skins of animals such as cattle and pigs. Gelatin chemically has as its main component a linear polymer of amino acids (protein). In general, gelatin is used as a food additive as a gelling agent or a thickener.

Usually, an aqueous gelatin solution gels at 25 °C or lower and dissolves at 30 °C or higher. Gelatin is classified into two types, acid-treated gelatin and alkali-treated gelatin, depending on the production method. Each of the gelatins has a different isoelectric point. The isoelectric point of the acid-treated gelatin has a wide range from 6 to 9, whereas the isoelectric point of the alkali-treated gelatin is in a narrow range around 5. Usually, use at a pH near the isoelectric point leads to a decrease in gel strength and turbidity of the gel.

In the present water-soluble film, it is preferable to use the alkali-treated gelatin from the viewpoint of excellent physical properties.

In the present water-soluble film, it is preferable to use a polysaccharide as the naturally derived material from the viewpoint of ease of improving mechanical properties such as strength and water sealing properties of the film. In particular, it is preferable to use pullulan or starch.

### Plasticizer

In the present water-soluble film, a plasticizer is preferably used from the viewpoint of imparting appropriate flexibility to the film. The plasticizer may be used alone or in combination of two or more thereof. It is also preferable to use two or more plasticizers in combination from the viewpoint of the mechanical properties and the moldability of the film.

Examples of the plasticizer include glycerins such as glycerin, diglycerin, and triglycerin; alkylene glycols such as diethylene glycol, triethylene glycol, polyethylene glycol, propylene glycol, polypropylene glycol, and dipropylene glycol; sugar alcohols such as sorbitol, xylitol, and maltitol; and trimethylolpropane. These may be used singly or in combination of two or more thereof. In particular, glycerin, diglycerin, and polyethylene glycol are preferred in that they are readily available and can achieve a plasticizing effect with a small amount. From the viewpoint of stability over time of the package, sorbitol is also preferred.

Such a plasticizer may be a naturally derived material, and among the specific examples described above, glycerol, sorbitol, xylitol, and maltitol are sugar alcohols and are included in the sugar alcohol of the naturally derived material described above.

The content of the plasticizer is preferably from 5 to 80 parts by mass, more preferably from 10 to 70 parts by mass, still more preferably from 15 to 60 parts by mass, particularly preferably from 18 to 50 parts by mass, and especially preferably from 20 to 45 parts by mass, per 100 parts by mass of the total of the PVA-based resin (A) and the naturally derived material (excluding the plasticizer and the filler). When the content of the plasticizer is too low, there is a tendency that the plasticizing effect is low, and processability decreases, and the toughness of the water-soluble film decreases over time in forming a package. When the content is too high, the strength of the film tends to decrease, or blocking tends to occur.

### Filler

The present water-soluble film may further contain a filler as necessary.

The filler is contained for the purpose of enhancing blocking resistance. Such a filler is not particularly limited. Either an organic filler or an inorganic filler may be used as the filler. Particularly, an organic filler is preferably used. These can be used singly or in combination of two or more thereof. The filler has an average particle size of preferably from 0.1 to 50 μm, more preferably from 1 to 35 μm.

The average particle size of the above filler is measured by a laser diffraction particle size distribution analyzer and calculated from a D50 value of the obtained cumulative volume distribution (particle size of cumulative 50% of particles).

The organic filler refers to a particulate substance (primary particles) formed of an organic compound and having any form such as a needle, rod, lamellar, scale, or spherical form; or an aggregate (secondary particles) of the particulate substance.

The organic filler is mainly selected from polymer compounds. Examples thereof include a melamine-based resin, a polymethyl (meth)acrylate-based resin, and a polystyrene-based resin, as well as biodegradable resins such as starch and polylactic acid. Among these, a polymethyl (meth)acrylate-based resin, a polystyrene-based resin, and biodegradable resins such as starch are preferred. In particular, starch is preferred from the viewpoint of dispersibility in the PVA-based resin (A).

Examples of the starch include raw starches (such as corn starch, potato starch, sweet potato starch, wheat starch, cassava starch, sago starch, tapioca starch, sorghum starch, rice starch, legume starch, kudzu starch, bracken starch, lotus starch, and water chestnut starch); physically modified starches (such as pregelatinized starch, fractionated amylose, and heat-moisture treated starch); enzymatically modified starches (such as hydrolyzed dextrin, enzymatically decomposed dextrin, and amylose); chemically degraded starches (such as acid-treated starch, hypochlorite-oxidized starch, and dialdehyde starch); and chemically modified starch derivatives (such as esterified starch, etherified starch, cationized starch, and crosslinked starch). Among these, raw starches, particularly corn starch and rice starch are preferably used from the viewpoint of ease of availability and cost efficiency.

When starch is used as the filler, the content of the starch as the filler is preferably from 0.5 to 50 parts by mass, more preferably from 1 to 40 parts by mass, and still more preferably from 2 to 30 parts by mass, per 100 parts by mass of the total of the PVA-based resin (A) and the naturally derived material excluding the starch as the filler. When the content ratio is too low, blocking properties tend to increase. When the content ratio is too high, the sealing properties of the film tend to decrease or moldability during production of a package tends to be reduced.

The organic filler preferably has an average particle size of 2 μm or more and 50 μm or less, more preferably 4 μm or more and 45 μm or less, still more preferably 10 μm or more and 40 μm or less, and particularly preferably 15 μm or more and 35 μm or less. When the average particle size is too small, blocking properties of the film tend to increase. When the average particle size is too large, there is a tendency that the particles of the filler are likely to aggregate with each other and dispersibility is reduced, and pinholes tend to be generated when the film is stretched during film processing.

The inorganic filler refers to a particulate substance (primary particles) formed of an inorganic compound and having any form such as a needle, rod, lamellar, scale, or spherical form; or an aggregate (secondary particles) of the particulate substance.

Examples of the inorganic filler include oxide-based inorganic compounds such as silica (silicon dioxide), diatomite, titanium oxide, calcium oxide, magnesium oxide, aluminum oxide, barium oxide, germanium oxide, tin oxide, and zinc oxide; talc, clay, kaolin, mica, asbestos, gypsum, graphite, glass balloons, glass beads, calcium sulfate, barium sulfate, ammonium sulfate, calcium sulfite, calcium carbonate, whiskered calcium carbonate, magnesium carbonate, dawsonite, dolomite, potassium titanate, carbon black, glass fibers, alumina fibers, boron fibers, processed mineral fibers, carbon fibers, hollow carbon spheres, bentonite, montmorillonite, copper powder, sodium sulfate, potassium sulfate, zinc sulfate, copper sulfate, iron sulfate, magnesium sulfate, aluminum sulfate, aluminum potassium sulfate, ammonium nitrate, sodium nitrate, potassium nitrate, aluminum nitrate, ammonium chloride, sodium chloride, potassium chloride, magnesium chloride, calcium chloride, sodium phosphate, and potassium chromate. These may be used singly or in combination of two or more thereof.

In particular, it is preferable to use oxide-based inorganic compounds and talc. It is more preferable to use titanium oxide, talc, and silica. It is still more preferable to use silica.

The inorganic filler preferably has an average particle size of 1 μm or more and 20 μm or less, more preferably 2 μm or more and 15 μm or less, and still more preferably 3 μm or more and 10 μm or less. When the average particle size is too small, flexibility and toughness of the film tend to decrease, and blocking properties tend to increase, for example. When the average particle size is too large, pinholes tend to be generated when the film is stretched during molding.

When the filler is used, the content of the filler is preferably from 1 to 30 parts by mass, more preferably from 1.5 to 25 parts by mass, and still more preferably from 2 to 20 parts by mass, per 100 parts by mass of the total of the PVA-based resin (A) and the naturally derived material (excluding the plasticizer and the filler). When the content ratio is too low, blocking properties of the film tend to increase. When the content ratio is too high, the flexibility and the toughness of the film tend to be reduced.

### Surfactant

The present water-soluble film may further contain a surfactant or the like as necessary.

The surfactant used in the present water-soluble film is contained for the purpose of improving peelability from the casting surface during film production. Examples thereof usually include nonionic surfactants, cationic surfactants, and anionic surfactants.

Examples of such surfactants include polyoxyethylene nonylphenyl ether, polyoxyethylene octylnonyl ether, polyoxyethylene dodecylphenyl ether, polyoxyethylene alkyl allyl ether, polyoxyethylene sorbitan monolaurate, polyoxyethylene sorbitan monopalmitate, polyoxyethylene sorbitan monostearate, polyoxyethylene sorbitan monooleate, polyoxyalkylene alkyl ether phosphate ester monoethanolamine salts, polyoxyethylene alkylamino ethers such as polyoxyethylene laurylamino ether and polyoxyethylene stearylamino ether, sorbitan monopalmitate, sorbitan monostearate, glycerol stearate, and sucrose fatty acid esters. Among these, a polyoxyalkylene alkyl ether phosphate ester monoethanolamine salt and polyoxyethylene laurylamino ether are preferred from the viewpoint of production stability. These can be used singly or in combination of two or more thereof.

The content of the surfactant is preferably from 0.01 to 3 mass %, more preferably from 0.05 to 2.5 mass %, and still more preferably from 0.1 to 2 mass %, of the water-soluble film. When the content is too low, the peelability between a casting surface of a film-forming apparatus and the formed film tends to be reduced, resulting in lower productivity. When the content is too high, blocking tends to occur, and adhesive strength during sealing when the film is used to form a package tends to be reduced.

### Additional Component

An additional component can also be contained within a range that does not impair the object of the present disclosure. Examples of the additional component include water-soluble polymers other than the PVA-based resin (A) and the above naturally derived material (e.g., sodium polyacrylate, polyethylene oxide, polyvinylpyrrolidone, methylcellulose, and hydroxyethylcellulose), as well as fragrances, rust inhibitors, colorants, bulking agents, antifoaming agents, ultraviolet absorbers, liquid paraffins, and fluorescent brighteners, bitter agents (e.g., denatonium benzoate), These can be used singly or in combination of two or more thereof.

The content of the additional component is preferably 5 parts by mass or less, more preferably 1 part by mass or less, and still more preferably 0.5 parts by mass or less, per 100 parts by mass of the total of the PVA-based resin (A) and the naturally derived material (excluding the plasticizer and the filler). The lower limit value is usually 0 parts by mass. The numerical range of the content is, for example, from 0 to 5 parts by mass. When the content is too high, compatibility with the naturally derived material tends to decrease and durability tends to decrease.

In the present embodiment, an antioxidant may be blended. Examples of the antioxidant include sulfites such as sodium sulfite, potassium sulfite, calcium sulfite, and ammonium sulfite; tartaric acid, ascorbic acid, sodium thiosulfate, catechol, and Rongalit. Among these, sulfites are preferred, and sodium sulfite is particularly preferred. The blended amount of the antioxidant is preferably from 0.1 to 10 mass %, more preferably from 0.2 to 5 mass %, and still more preferably from 0.3 to 3 mass %, of the water-soluble film.

### Production of Present Water-Soluble Film

In the present embodiment, as described above, the PVA-based resin (A) and the naturally derived material, preferably a plasticizer, and if necessary, an additional component, example of which including a filler and a surfactant, are blended, and dissolved or dispersed using water to prepare a film-forming raw material, and the film-forming raw material is formed into a film.

### Dissolution Step

In a dissolution step, the blended components are dissolved or dispersed in water to prepare an aqueous solution or an aqueous dispersion serving as a film-forming raw material.

In the preparation of the film-forming raw material, the method of mixing the PVA-based resin (A), the naturally derived material, and the additional additive is not particularly limited. Examples thereof include a method including mixing the naturally derived material, the PVA-based resin (A), and the additional additive to yield a mixture, and mixing the mixture with water and dissolving the mixture in water; a method including separately dissolving the PVA-based resin (A) in water, the naturally derived material in water, and the additional additive in water and then mixing the resulting mixtures; and a method including separately dissolving the PVA-based resin (A) in water and the naturally derived material in water, and then mixing the resulting mixtures with the additional additive to be dissolved.

Typically, normal-temperature dissolution, high-temperature dissolution, pressurized dissolution, or the like is employed as a dissolution method for dissolution in water. Among these, high-temperature dissolution and pressurized dissolution are preferred from the viewpoint of less undissolved matter and excellent productivity.

The dissolution temperature is usually from 80 to 100 °C, preferably from 90 to 100 °C in the case of the high-temperature dissolution, and usually from 80 to 130 °C, preferably from 90 to 120 °C in the case of the pressurized dissolution.

The dissolution time is usually from 1 to 20 hours, preferably from 2 to 15 hours, and more preferably from 3 to 10 hours. When the dissolution time is too short, undissolved matter tends to remain, and when it is too long, the productivity tends to decrease.

Further, after the dissolution, the obtained film-forming raw material is subjected to a defoaming treatment. Examples of the defoaming method include static defoaming, vacuum defoaming, and twin-screw extrusion defoaming. In particular, static defoaming and twin-screw extrusion defoaming are preferred.

The defoaming temperature is usually from 50 to 100 °C, preferably from 60 to 95 °C, and more preferably from 65 to 80 °C. When the defoaming temperature is too high, the molecular chains of the naturally derived material tend to be cleaved, and the viscosity of the film-forming raw material tends to decrease. When it is too low, there is a tendency that the viscosity increases, it takes a longer time for defoaming, and the productivity decreases.

The defoaming time is usually from 2 to 30 hours, preferably from 5 to 25 hours.

The film-forming raw material preferably has a solid content concentration of 10 mass % or more and 60 mass % or less, more preferably 12 mass % or more and 50 mass % or less, and still more preferably 15 mass % or more and 40 mass % or less. When the concentration is too low, the productivity of the film tends to be reduced. When the concentration is too high, there is a tendency that the viscosity is too high, it takes a longer time to defoam the film-forming raw material, and a die line is caused during film formation.

The pH of the film-forming raw material is usually from 4 to 8, preferably from 4.8 to 7.5.

### Film Forming Step

In a film forming step, the film-forming raw material prepared in the dissolution step is formed into a film, optionally subjected to a drying treatment, and thus the film is adjusted to a water-soluble film having a moisture content of less than 15 mass %.

As the film forming method, methods such as a melt extrusion method or a casting method can be employed. From the viewpoint of accuracy in film thickness, the casting method is preferred.

When the casting method is performed, for example, the above film-forming raw material is ejected from a slit such as a T-shaped slit die and cast onto a casting surface, such as a metal surface of an endless belt or a drum roll, or a surface of a plastic substrate such as a polyethylene terephthalate film, dried, and, if necessary, further subjected to heat treatment to produce a water-soluble film.

The water-soluble film peeled from the casting surface such as a surface of a plastic substrate in the film-forming step is conveyed and wound around a core to yield a film roll. The formed film roll can be supplied as a product as it is, but it can preferably be also supplied as a film roll including the water-soluble film slitted to a film width of a desired size.

The present water-soluble film is thus obtained.

The viscosity of a 1 mass % aqueous solution of the water-soluble film at 20 °C is from 2.00 to 2.60 mPa·s, and the lower limit value is preferably 2.03 mPa·s or more, more preferably 2.05 mPa·s or more, still more preferably 2.10 mPa·s or more, and particularly preferably 2.15 mPa·s or more. The upper limit value is 2.60 mPa·s or less, preferably 2.55 mPa·s or less, more preferably 2.50 mPa·s or less, and still more preferably 2.45 mPa·s or less.

When the viscosity is too low or too high relative to the range specified in the present disclosure, the water sealing properties of the water-soluble film tend to decrease.

The viscosity of the 1 mass % aqueous solution of the water-soluble film at 20 °C is a value measured by a viscosity measurement method using a falling ball viscometer as described in “JIS Z 8803:2011 Method for viscosity measurement of liquid,” and can be measured by the method described in Examples below.

In the present embodiment, the viscosity of the 1 mass % aqueous solution, which is low concentration, is defined, while this viscosity serves as an index of the viscosity in a state in which polymer chains are extended with little influence of interactions between the polymers. This is because the greater the extent to which polymer chains are extended when the polymer contained in the film is dissolved in water, the more entanglement during sealing increases and the sealing properties increase. Thus, in the present embodiment, the viscosity of the water-soluble film in a so-called dilute solution is important.

The surface of the present water-soluble film may be plain, but it is also preferable to subject one or both surfaces of the film to uneven processing such as an embossed pattern, a fine uneven pattern, or a special engraved pattern, from the viewpoint of blocking resistance, slipperiness during processing, reduction in adhesion between products, and appearance.

The thickness of the present water-soluble film is appropriately selected depending on, for example, the application, but is preferably from 10 to 120 μm, more preferably from 15 to 110 μm, and still more preferably from 20 to 100 μm. When the thickness is too small, the mechanical strength of the film tends to be reduced. When the thickness is too large, the rate of dissolution in water tends to decrease and the film forming efficiency also tends to be reduced.

The width of the present water-soluble film is appropriately selected depending on, for example, the application, but is preferably from 300 to 5000 mm, more preferably 500 to 4000 mm, and still more preferably 600 to 3000 mm. When the width is too small, the productivity tends to be reduced. When the width is too large, controlling slack and film thickness tends to be difficult.

The length of the present water-soluble film is appropriately selected depending on, for example, the application and the like, but is preferably from 100 to 20000 m, more preferably from 800 to 15000 m, and still more preferably from 1000 to 10000 m. When the length is too short, there is a tendency that film switching requires time-consuming and the productivity is reduced. When it is too long, appearance defects due to tight winding tend to occur.

The present water-soluble film preferably has a moisture content of 3 mass % or more and 15 mass % or less, more preferably 5 mass % or more and 9 mass % or less, and still more preferably 6 mass % or more and 8 mass % or less, from the viewpoint of mechanical strength and heat-sealability. When the moisture content is too low, there is a tendency that it is too hard for the film to, when formed into a package, reduce the moldability and the impact resistance of the package. When the moisture content is too high, blocking tends to occur. Adjustment of the moisture content can be achieved by appropriately setting the drying conditions and humidity control conditions.

The moisture content is measured in accordance with JIS K 6726 3.4, and a value of the resulting volatile content is defined as the moisture content.

The tensile strength of the present water-soluble film is preferably 5 MPa or more, more preferably 10 MPa or more, and still more preferably 13 MPa or more. The upper limit value is not particularly limited, but is usually 100 MPa or less, preferably 60 MPa or less. The numerical range of the tensile strength is, for example, from 5 to 100 MPa. When the tensile strength is within such a range, mechanical properties such as strength and stretchability at the time of packaging become enhanced.

The tensile strength of the present water-soluble film can be measured by the method described in Examples below.

The tensile elongation at break of the present water-soluble film is preferably 200% or more, more preferably more than 300%, and still more preferably 330% or more. The upper limit value is not particularly limited, but is usually 800% or less, and preferably 600% or less. The numerical range of the tensile elongation at break is, for example, from 200 to 800%. When the tensile elongation at break is within such a range, mechanical properties such as strength and stretchability at the time of packaging become enhanced.

The tensile elongation at break of the present water-soluble film can be measured by the method described in Examples below.

The present water-soluble film may be used as a single layer or may be used as a multilayer structure containing an additional film or resin layer laminated.

The present water-soluble film thus obtained is particularly useful for packaging (unit packaging) applications of chemicals such as agricultural chemicals and detergents, and for edible applications (food packaging). The food to be packaged with the film may be, for example, in a granular form, a tablet form, or a powdery form. The food is preferably a dried food, for example, an ingredient and a seasoning for instant foods.

### Chemical Agent Package

A chemical agent package according to one embodiment of the present disclosure (hereinafter referred to as “the present chemical agent package”) includes a package formed of the present water-soluble film and a chemical agent enclosed in the package. These will be described below.

The present chemical agent package is produced by covering the chemical agent with the package made of the present water-soluble film produced. In the chemical agent package, the chemical agent is packaged in the package formed of the present water-soluble film. Thus, when the chemical agent is introduced into water together with the package, the package (water-soluble film) on the surface dissolves to expose the chemical agent, and the chemical agent can be dissolved or dispersed in water to exhibit its effect. Therefore, the present chemical agent package is preferred as a chemical agent package that encloses a relatively small amount, for example, a single unit of the chemical agent.

Although the shape of the present chemical agent package is appropriately selected and is not particularly limited, examples thereof include a substantially cubic shape, a substantially spherical shape, a substantially oblate spheroidal shape, and a substantially teardrop shape. The present chemical agent package may be composed of a single compartment or may have a plurality of compartments.

Although the number of the plurality of compartments in the present chemical agent package is not particularly limited and is appropriately selected depending on, for example, the type of contents, the number of the plurality of compartments is, for example, from 2 to 10 compartments, preferably from 3 to 8 compartments, and more preferably from 4 to 6 compartments. It is preferable that different types of contents are packaged in the respective compartments of the plurality of compartments.

The surface of the present chemical agent package is usually smooth, but from the viewpoint of blocking resistance, slipperiness during processing, reduction in adhesion between products (individual packages), and appearance, the outer surface of the package (water-soluble film) may be subjected to uneven processing such as an embossed pattern, a fine uneven pattern, or a special engraved pattern.

Examples of the chemical agent include agricultural chemicals such as insecticides, fungicides, and herbicides; fertilizers; and detergents. In particular, detergents such as laundry detergents and dishwashing detergents are preferred. Such a chemical agent may be in the form of liquid or solid, and examples of the solid form include a granular form, a tablet form, and a powdery form. The chemical agent is preferably a chemical agent used by dissolving or dispersing such a chemical agent in water. Particularly preferably, a liquid detergent is enclosed. The pH of such a chemical agent may be alkaline, neutral, or acidic.

The liquid detergent preferably has a pH of 6 or more and 12 or less, more preferably 7 or more and 11 or less, when dissolved or dispersed in water to a concentration of 1 mass %. The liquid detergent preferably has a water content of 15 mass % or less, more preferably from 0.1 to 10 mass %, and still more preferably from 0.1 to 7 mass %. When the water content of the liquid detergent is within the above range, there is a tendency that the water-soluble film is free from gelation and insolubilization and has excellent water solubility.

The pH value is measured in accordance with JIS K 3362 8.3. The water content is measured in accordance with JIS K 3362 7.21.3.

### Production of Chemical Agent Package

To form a chemical agent package by packaging a chemical agent such as a liquid detergent using the present water-soluble film, a known method can be employed.

For example, the chemical agent package can be produced by disposing a chemical agent between two water-soluble films (a first water-soluble film and a second water-soluble film) facing each other, and pressure-bonding the overlapping portions (contact portions) of the water-soluble films around the chemical agent.

Specifically, a concave part having a shape in which a chemical agent can be placed is prepared as a lower mold of a molding apparatus, and the first water-soluble film (bottom film) is fixed to the lower mold to mold the bottom film into a shape along the lower mold.

Meanwhile, the second water-soluble film (top film) is fixed to an upper mold of the molding apparatus. Subsequently, a separately prepared chemical agent such as a liquid detergent is placed (introduced) into the molded bottom film, and then the upper mold and the lower mold are compressed to contact the top film and the bottom film around the chemical agent with each other, and the contact portion is pressure-bonded under vacuum. After the pressure-bonding, the vacuum is released, and a chemical agent package with the chemical agent enclosed in the water-soluble film can be produced.

Examples of the method of pressure-bonding the film include a heat-sealing method, a water-sealing method, and a glue-sealing method. Among these, a water-sealing method is preferably used from the viewpoint of easy control of pressure-bonding conditions, for example.

### EXAMPLES

The present disclosure will be described more specifically with reference to Examples below. However, the present disclosure is not limited to Examples below unless the gist of the present disclosure is exceeded.

In Examples, “parts” is meant to be on a mass basis.

The following materials were prepared as material components of a water-soluble film.

### PVA-Based Resin (A)

PVA1 (carboxy group-modified PVA-based resin): 4 mass % aqueous solution viscosity at 20 °C of 22 mPa·s, average degree of saponification of 94 mol %, and degree of modification with monomethyl maleate of 2.0 mol %
PVA 2 (unmodified PVA): 4 mass % aqueous solution viscosity at 20 °C of 43 mPa·s, and average degree of saponification of 88 mol %.
PVA 3 (unmodified PVA): 4 mass % aqueous solution viscosity at 20 °C of 5 mPa·s, and average degree of saponification of 88 mol %.

### Naturally Derived Material

Naturally Derived Materials Other than Plasticizer
Gelatin: “#200” manufactured by Nitta Gelatin Inc., alkali treated (weight-average molecular weight: 100000)
Pullulan: Pullulan manufactured by Hayashibara Co., Ltd. (weight-average molecular weight: 200000)
Collagen: “Collagen Peptide” manufactured by FUJIFILM Corporation, enzymatically degraded product (weight-average molecular weight: 2000)
Starch 1: Pregelatinized starch (amylopectin content: 100%; “Waxy Alpha Y” manufactured by Sanwa Starch Co., Ltd.) (weight-average molecular weight: 1000000 or more)
Casein: “Sodium Caseinate 180” manufactured by Fonterra Co-operative Group Limited (weight-average molecular weight: 23000) Filler
Starch 2: Corn starch, having an average particle size of 20 μm (which disperses in water at about 20 °C without dissolving, and functions as a filler)

### Plasticizer

Plasticizer 1: Glycerin
Plasticizer 2: Sorbitol
   Materials Other than Naturally Derived Materials

### Surfactant

Polyoxyalkylene alkyl ether phosphate ester monoethanolamine salt

### Example 1

Together with water, 40 parts of the carboxy group-modified PVA-based resin (PVA1) and 10 parts of the unmodified PVA (PVA2) as a PVA-based resin, 50 parts of Starch 1 as a naturally derived material, 20 parts of glycerol as a plasticizer, and 0.2 parts of the polyoxyalkylene alkyl ether phosphate monoethanolamine salt as a surfactant were mixed to yield a film-forming raw material, which is an aqueous dispersion of a resin composition having a solid content concentration of 25 mass %.

The obtained film-forming raw material was cast onto a polyethylene terephthalate film, dried by being passed through a drying chamber (105 °C) having a length of 3 m at a speed of 0.40 m/min, and thus a water-soluble film (moisture content: 7 mass %) having a thickness of 87 μm was obtained.

### Example 2

Together with water, 65 parts of the carboxy group-modified PVA-based resin (PVA1) as a PVA-based resin, 35 parts of pullulan as a naturally derived material, 8 parts of corn starch (Starch 2) as a filler, 20 parts of glycerol and 20 parts of sorbitol as plasticizers, 0.2 parts of the polyoxyalkylene alkyl ether phosphate monoethanolamine salt as a surfactant were mixed to yield a film-forming raw material, which is an aqueous dispersion of a resin composition having a solid content concentration of 10 mass %. A water-soluble film having a thickness of 100 μm (moisture content: 7.5 mass %) was obtained in the same manner as in Example 1 except for the above.

### Example 3

Together with water, 50 parts of the carboxy group-modified PVA-based resin (PVA1) as a PVA-based resin, 50 parts of pregelatinized starch (Starch 1) as a naturally derived material, and 20 parts of glycerol as a plasticizer were mixed to yield a film-forming raw material, which is an aqueous dispersion of a resin composition having a solid content concentration of 30 mass %. A water-soluble film having a thickness of 87 μm (moisture content: 7.1 mass %) was obtained in the same manner as in Example 1 except for the above.

### Example 4

A water-soluble film having a thickness of 89 μm (moisture content: 7.5 mass %) was obtained in the same manner as in Example 3, except that the composition of a resin composition was changed to the components and the amounts shown in Table 1 below.

### Comparative Examples 1 to 3

Water-soluble films having a thickness of 86 μm (moisture content: 7 mass %) were obtained in the same manner as in Example 1, except that the compositions of resin compositions were changed to the components and the amounts shown in Table 1 below.

TABLE 1

| | | | | | | | | Content of | |
|---|---|---|---|---|---|---|---|---|---|
| | | | Naturally Derived Material | | | | | Naturally | Viscosity of |
| | | | Naturally | | | | | Derived | 1 mass % |
| | PVA- | | Derived | | | | | Material | Aqueous |
| | Based | | Material Other | | | | | (mass % in | Solution |
| | Resin | | than Plasticizer | | Plasticizer 1 | Plasticizer 2 | Filler | film) | (mPa · s) |
| Example 1 | PVA1 | 40 | Starch 1 | 50 | 20 | — | — | 52.3 | 2.44 |
| | PVA2 | 10 | | | | | | | |
| Example 2 | PVA1 | 65 | Pullulan | 35 | 20 | 20 | 8 | 56.1 | 2.19 |
| Example 3 | PVA1 | 50 | Starch 1 | 50 | 20 | — | — | 58.3 | 2.39 |
| Example 4 | PVA1 | 75 | Starch 1 | 25 | 35 | 35 | — | 55.9 | 2.07 |
| Comparative | PVA2 | 60 | Collagen | 30 | 20 | 20 | 8 | 52.7 | 1.95 |
| Example 1 | PVA1 | 10 | | | | | | | |
| Comparative | PVA3 | 35 | Casein | 50 | 20 | — | — | 46.7 | 1.60 |
| Example 2 | PVA2 | 15 | | | | | | | |
| Comparative | PVA1 | 40 | Gelatin | 60 | 10 | — | 8 | 62.1 | 2.70 |
| Example 3 | | | | | | | | | |

Using the water-soluble films thus obtained, the viscosity of the 1 mass % aqueous solution was measured by the method described below. The results are shown in Table 1 as well. The mechanical properties and the water sealing properties of the water-soluble films were also evaluated based on the methods and criteria described below. The results are shown in Table 2 below.

### Aqueous Solution Viscosity

The viscosity of an aqueous solution obtained by dissolving 0.7 g of each of the water-soluble films obtained above in 69.3 g of water at 23 °C was measured. That is, the aqueous solution was prepared to have a concentration of 1 mass % based on the mass of each of the films, and the viscosity was measured at 20 °C by a viscosity measurement method using a falling ball viscometer described in “JIS Z 8803:2011 Method for viscosity measurement of liquid.” Before dissolved in water, the water-soluble film to be used was allowed to stand under humidity conditioning conditions of 23 °C and 50% RH for 24 hours. The time from the preparation of the aqueous solution to the viscosity measurement was within 8 hours.

The viscosity was measured after dissolving the water-soluble film in water, allowing the resulting solution to stand at 20 °C for 3 hours, and removing any material precipitated as an insoluble substance (for example, starch as a filler).

### Mechanical Properties

### Tensile Strength and Tensile Elongation at Break

Using the water-soluble films obtained above, the “tensile strength” and the “tensile elongation at break” were measured in accordance with JIS K 7127 (1999). That is, prior to measurement, each of the water-soluble films was allowed to stand under humidity conditioning conditions of 23 °C and 50% RH for 24 hours, and then, under these conditions, the tensile strength and the tensile elongation at break of each of the water-soluble films were measured at a tensile speed of 200 mm/min using an Autograph AG-X Plus (manufactured by Shimadzu Corporation) (film width: 15 mm, distance between grips: 50 mm). These measured values were evaluated based on the following criteria.

### Evaluation Criteria

⊚ (excellent): tensile strength was 10 MPa or more and tensile elongation at break was more than 300%.

◯ (very good): tensile strength was 10 MPa or more and tensile elongation at break was from 200% to 300%, or tensile strength was 5 MPa or more and less than 10 MPa and tensile elongation at break was more than 300%.

Δ (good): tensile strength was 5 MPa or more and less than 10 MPa and tensile elongation at break was from 200 to 300%.

x (poor): tensile strength was from 0 to less than 5 MPa and/or tensile elongation at break was less than 200%.

### Water Sealing Properties

From each of the water-soluble films obtained above, a 100 mm×200 mm piece (top film) and a 100 mm×100 mm piece (bottom film) were cut, and a water sealing test was conducted. That is, the water-soluble films were allowed to stand under humidity conditioning conditions of 23 °C and 40% RH for 24 hours. Subsequently, under these conditions, the water-soluble film (bottom film) was fixed on a square glass plate having a side length of 30 cm and water was applied to the bottom film using a PVA sponge roller (“Cygnus Roller” manufactured by Aion Co., Ltd.) impregnated with water. Next, the water-soluble film (top film) was placed on the water-soluble film (bottom film) with water applied, and the top film and the bottom film were pressure-bonded by rolling another rubber roller (width: 250 mm; diameter: 60 mm; weight: 2750 g) over the top film and the bottom film twice. Thus a test piece was prepared.

After 2 minutes, the peel strength of a sealed portion of the test piece was measured at a tensile speed of 100 mm/min using an Autograph AG-X Plus (manufactured by Shimadzu Corporation) (film width: 15 mm; distance between grips: 20 mm). The failure state of the sealed portion in the water sealing test, or the average test force between strokes of 50 mm or more and 100 mm or less, was evaluated based on the following criteria.

### Evaluation Criteria

◯ (very good): the average test force was 5 N/15 mm or more and cohesive failure occurred at the sealed portion.

Δ (good): the average test force was 3 N/15 mm or more and less than 5 N/15 mm, and cohesive failure occurred at the sealed portion.

x (poor): the average test force was less than 3 N/15 mm, or interfacial peeling occurred at the sealed portion.

TABLE 2

| | Mechanical | Water sealing |
|---|---|---|
| | properties | properties |
| Example 1 | ○ | ○ |
| Example 2 | ○ | ○ |
| Example 3 | ○ | ○ |
| Example 4 | ○ | Δ |
| Comparative | ○ | x |
| Example 1 | | |
| Comparative | ○ | x |
| Example 2 | | |
| Comparative | x | x |
| Example 3 | | |

From the results of Table 2, it can be seen that the films of Examples 1 to 4, each having a viscosity of a 1 mass % aqueous solution (dilute solution viscosity) within a predetermined viscosity range, had excellent mechanical properties and also had excellent water sealing properties. In contrast, the films of Comparative Examples 1 to 3, each having a viscosity of a 1 mass % aqueous solution (dilute solution viscosity) outside the predetermined viscosity range, all exhibited poor water sealing properties.

Since the water-soluble films of Examples have excellent mechanical properties and water sealing properties, each of the water-soluble films is suitable for packaging applications. Also, a package produced using such a water-soluble film has excellent mechanical properties and water sealing properties.

Specific embodiments of the present disclosure are described in Examples. However, Examples are merely illustrative and are not to be construed as limiting. Various modifications apparent to those skilled in the art are intended to be within the scope of the present disclosure.

### INDUSTRIAL APPLICABILITY

The present water-soluble film can be used for packaging (unit packaging) applications of chemical agents such as agricultural chemicals and detergents; for (hydraulic) transfer films; for sanitary products such as sanitary pads and disposable diapers; bodily waste disposal products such as ostomy bags; medical products such as blood absorbent sheets; and temporary base materials such as germination sheets, seed tapes, and embroidery base fabrics.

In addition, the present water-soluble film is a blend film of a PVA-based resin and a naturally derived material, both of which are also used in foods and pharmaceuticals. Thus, the present water-soluble film is also useful for edible applications (food packaging).

1. A water-soluble film comprising:
a polyvinyl alcohol-based resin; and
at least one naturally derived material selected from the group consisting of a saccharide, a sugar alcohol, a lipid, a protein, and a salt thereof,
wherein a content of the naturally derived material is 40 mass % or more based on 100 mass % of the water-soluble film (solid content), and
a viscosity of a 1 mass % aqueous solution of the water-soluble film at 20 °C is from 2.00 to 2.60 mPa·s.

2. The water-soluble film according to claim 1, wherein the naturally derived material includes a naturally derived material having a weight-average molecular weight of 10000 or more.

3. A method for producing the water-soluble film according to claim 1, the method comprising:
preparing a film-forming raw material containing the polyvinyl alcohol-based resin and the naturally derived material;
casting the film-forming raw material onto a casting surface; and
drying the film-forming raw material cast on the casting surface.

4. A package comprising the water-soluble film according to claim 1.

5. A chemical agent package comprising:
a package containing the water-soluble film according to claim 1, and
a chemical agent enclosed in the package.

6. The chemical agent package according to claim 5, wherein the chemical agent is a liquid detergent.

7. A method for producing the chemical agent package according to claim 5, the method comprising:
preparing a first water-soluble film, a second water-soluble film, and the chemical agent;
placing the chemical agent between the first water-soluble film and the second water-soluble film; and
contacting and pressure-bonding the first water-soluble film and the second water-soluble film.
